(19) United States
(12) Patent Application Publication
(10) Pub. No.: US 2017/0286567 A1
(43) Pub. Date: Oct. 5, 2017

(54) Interactive Digital Drawing and Physical Realization

(71) Applicant: Barbara Hana, New York, NY (US)

(72) Inventor: Barbara Hana, New York, NY (US)

(21) Appl. No.: 15/628,387

(22) Filed: Jun. 20, 2017

Related U.S. Application Data
(63) Continuation-in-part of application No. 14/619,891, filed on Feb. 11, 2015.
Application No. 14/619,891 is a continuation of application No. 14/511,049, filed on Oct. 9, 2014, now Pat. No. 8,983,646.
(60) Provisional application No. 61/889,459, filed on Oct. 10, 2013.

(51) Int. Cl. G06F 17/50

(52) U.S. Cl. CPC G06F 17/50; B29C 67/0059

(57) ABSTRACT

Inventive systems and methods for interactively producing 3D realizations of vector graphics are disclosed. A vector graphic primitive is defined and then used to construct more complex, composite vector graphics from which volume encompassing 3D printable meshes are generated. This 3D printable meshes are automatically converted into instructions for a 3D printer that then produces a physically realized object corresponding in shape and size to the composite vector graphic. In one embodiment, the composite vector graphic is a constructed using a predetermined growth algorithm that automatically generates a number of start-locations at which instantiations of the vector graphic primitive are produced. In a further embodiment, 3D lattice structures are produced using unit cells as vector graphic primitives and the vertices of a 3D lattice as the growth algorithms.

### CLAIM OF PRIORITY

This application is a continuation-in-part of U.S. application Ser. No. 14/619,891 filed on Feb. 7, 2017, which is a continuation of U.S. application Ser. No. 14/511,049 filed on Oct. 9, 2014, which issued as U.S. Pat. No. 8,983,646 on May 17, 2015, and which in turn claims priority to U.S. provisional application Ser. No. 61/889,459 filed on Oct. 10, 2013 the contents of all of which are hereby fully incorporated by reference.

### FIELD OF THE INVENTION

The invention relates to computer aided design, and the physical realization of the designs, and more particularly to systems and methods for converting vector graphics into physically realized objects using 3D printing.

### BACKGROUND OF THE INVENTION

3D printing is a well-known technology used to produce 3D physical objects. Most 3D printers use computer files generated from a computer generated 3D CAD/CAM, animation or dedicated modeling software. Computer programs are typically used to convert these 3D engineering models into a succession of slices that may then be built up by printing one layer at a time.

A data interface between the modeling software and the 3D printing machines may, for instance, be the Stereo Lithography (STL) file format. An STL file stores the shape of a part using triangular facets. Other common formats include the Additive Manufacturing File Format (AMF), the Polygon File Format (PLY) and the Stanford Triangle Format.

To perform a print, a 3D printer typically reads the design from an STL file, converts it into a preparatory code such as, but not limited to, G-Code, and then uses those instructions to lay down successive layers of liquid, powder, paper or sheet material and so create 3D physical realizations of the model as a series of cross-sections. These layers, each of which corresponds to a virtual cross-section calculated from the CAD model, are deposited, joined or automatically fused to create the final shape. The primary advantage of this technique is its ability to create almost any shape or geometric feature.

There are a variety of 3D printing methods including, but not limited to, selective laser sintering (SLS), fused deposition modeling (FDM), direct metal laser sintering (DMLS), selective laser melting (SLM), or stereo-lithography (SLA) or some combination thereof.

The materials that may be 3D printed include materials such as, but not limited to, thermoplastics, thermoplastic powder, resins, photopolymers, Titanium alloys, stainless steel, aluminum, or ceramics, or some combination thereof.

3D printing of an object may take anywhere from 30 minutes to several days, depending on the method used and the size and complexity of the model.

It is a rapidly evolving arena. 3D printing originally referred to a process that deposits a binder material onto a powder bed with inkjet printer heads layer by layer. More recently, the term is being used in popular vernacular to encompass a wider variety of additive and non-additive manufacturing (AM) techniques. United States and global technical standards use the official term additive manufacturing for this broader sense. ISO/ASTM52900-15 now defines seven categories of AM processes within its meaning: binder jetting, directed energy deposition, material extrusion, material jetting, powder bed fusion, sheet lamination and vat photopolymerization.

### SUMMARY OF THE INVENTION

Inventive systems and methods for interactively producing 3D realizations of vector graphics are disclosed.

In a preferred embodiment, a drawing device may be used to define a vector graphic primitive. The vector graphic primitive may, for instance, be of a particular type such as, but not limited to, one of a line drawing or a predetermined shape, or a combination thereof. The vector graphic primitive may have no volume, but merely be a mathematically defined, 1-dimensional line having a start, and an end, point. Or it may be a series of lines joined by their start and end points. The system may then automatically convert the vector graphic primitive into a 3D printable mesh. The 3D printable mesh may be a volume encompassing mesh, such as, but not limited to, a mathematical model of a triangulated mesh. The system may then automatically convert the 3D printable mesh into a format that may be used by a 3D printer. A 3D printer may then be used to print a 3D printed object that may be a physically realized object corresponding in shape and size to the vector graphic primitive.

The conversion from a vector graphic primitive to a 3D printable mesh may, for instance, be accomplished automatically by a software module operating on a digital computing device. The software module may proceed by first generating a mathematical model of an n-sided polygon in the vicinity of each start or end point of the vector graphic primitive. Each of the n vertices of the n-sided polygon may then be joined by a computer generated mathematical line to a corresponding vertex on the next adjacent polygon. Each vertex may also be joined to an adjacent vertex on the next adjacent polygon. The process may be continued until all polygons are joined in the same manner, resulting in a mathematical model of a 3D printable mesh that may correspond in shape to the vector graphic. Although this 3D printable mesh is typically a triangulated mesh, other polygons may be used to create such a mesh.

In a further preferred embodiment of the invention, the vector graphic primitive may be used to construct more complex, composite vector graphics. A user may, for instance, select a predefined primitive type such as, but not limited to, a user-input sketch, and then select one or more object start-locations in a current input plane that may be displayed on a drawing device. The system may then automatically generate an instantiation of the vector graphic primitive at each selected start location, creating a composite vector graphic. This composite vector graphic may be converted into a 3D printable mesh, and that mesh into a file format suitable for 3D printing. A 3D object, corresponding in shape and size to the composite vector graphic, may then be realized by a 3D printer.

In yet a further embodiment of the invention, the selection of start locations may be done automatically by, for instance, a user selected, predetermined growth algorithm.

The predetermined growth algorithm may, for instance, generate the vertices of a 3D lattice structure, and the vector graphic primitive a cube-shaped wire frame. By automatically generating instantiations of the user-selected unit-cell at each of the object start-locations defined by the vertices of the 3D lattice structure, a composite vector graphic may be generated that may be a wire-frame model of a 3D lattice. This wire-frame model of a 3D lattice may then be automatically converted to a 3D printable mesh, that may in turn be printed by a 3D printer as an object that is a 3D lattice.

The growth model may, for instance, mimic biological models, or be based on mathematical models, or a set of empirical rules, that may, for instance, be designed to provide specific, desirable, structural, aesthetic, material or meta-material characteristics to the realized object.

The vector graphic primitive may also, or instead, be predefined objects such as, but not limited to, a convex polyhedron, a cube, a parallelepiped, a sphere, a diamond, a pyramid, or an ellipsoid, or some combination thereof. These may be generated using methods described in more detail below.

In yet a further embodiment of the invention, the vector graphic primitive may be defined as a 3D vector graphic using the drawing device by inputting locations of the locations of the vertices as x, y coordinates on a succession of 2D planes, with the succession of planes rotated with respect to each other. For instance, a first 2D input plane may be selected and displayed on a drawing device. On that first 2D input plane, the user may select, or define, a start point. The user may also define one or more additional vertices of the vector graphic by x, y coordinates, referenced within that first 2D input plane. The user may then select, or translate to, a second 2D input plane that may be rotated with respect to the first 2D input plane by a first angle of rotation. The user may then define one or more additional vertices of the vector graphic by x, y coordinates, referenced within that second 2D input plane. These may include an end point of the vector graphic. The system may then integrate the vertices input as x, y coordinates in the first and second 2D input planes into a set of vertices having x, y, z coordinates in a single coordinate frame of reference. In this way, a 2D input device such as, but not limited to, a 2D touch screen, may be used to define and input a 3D model or set of vector graphic vertices.

The 2D planes may also be useful even when operating in a 3D environment, such as, but not limited to, a 3D virtual reality environment.

Therefore, the present invention succeeds in conferring the following, and others not mentioned, desirable and useful benefits and objectives.

It is an object of the present invention to provide a system and method to rapidly create and realize composite 3D vector graphics from vector graphic primitives.

### BRIEF DESCRIPTION OF THE DRAWINGS

FIG. 1 shows schematic representation of a system of the present invention for interactively producing a 3D representation of a vector graphic.

FIG. 2 shows a schematic representation of a vector graphic.

FIG. 3 shows a schematic representation of a step in converting a vector graphic into a 3D machine readable object.

FIG. 4 shows a schematic representation of a further step in converting a vector graphic into a 3D machine readable object.

FIG. 5 shows a schematic representation of a vector graphic converted into a 3D mesh.

FIG. 6 shows a schematic flow chart of steps in a method for producing a 3D print from a vector graphic.

FIG. 7A shows a schematic rendering of a vector graphic primitive of one embodiment of the present invention.

FIG. 7B shows a schematic rendering of a composite vector graphic of one embodiment of the present invention.

FIG. 8A shows a schematic rendering of a user-selected unit-cell of one embodiment of the present invention.

FIG. 8B shows a schematic rendering of a predetermined growth algorithm of one embodiment of the present invention.

FIG. 8C shows a schematic rendering of a 3D printed lattice of one embodiment of the present invention.

FIG. 9 shows a schematic rendering of a 3D printed cube of one embodiment of the present invention.

FIG. 10A shows a schematic rendering of a polygons approximating a sphere of one embodiment of the present invention.

FIG. 10B shows a schematic rendering of a sphere approximated by tessellated polygons of one embodiment of the present invention.

FIG. 10C shows a schematic rendering of a 3D printed spherical mesh of one embodiment of the present invention.

FIG. 10D shows a schematic rendering of a 3D printed sphere of one embodiment of the present invention.

FIG. 11A shows a schematic rendering of a drawing device of one embodiment of the present invention.

FIG. 11B shows a schematic rendering of a drawing device of a further embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

A neglected area of 3D printing is the 3D physical realization of digital drawing such as, but not limited to, 2D and 3D line drawings These physical realizations may be 3D structures or physical objects that give volumetric form to line drawings such as handwritten messages, signatures, caricatures or cartoons, or they may be close approximations to curves representative of a motion through time, varying from, for instance, a doodle created by a finger moving on a touch screen or through gesture, a ballet dancer's movement during a performance captured by stereo cameras to a journey in a car captured by a GPS system.

These line drawings essentially have no width when represented mathematically. The problem, therefore, is to convert what is essentially a one dimensional object into a 3D representation that may be printed by a 3D printer, preferably in a computationally efficient manner that results in a design that may be rapidly printed by a 3D printer.

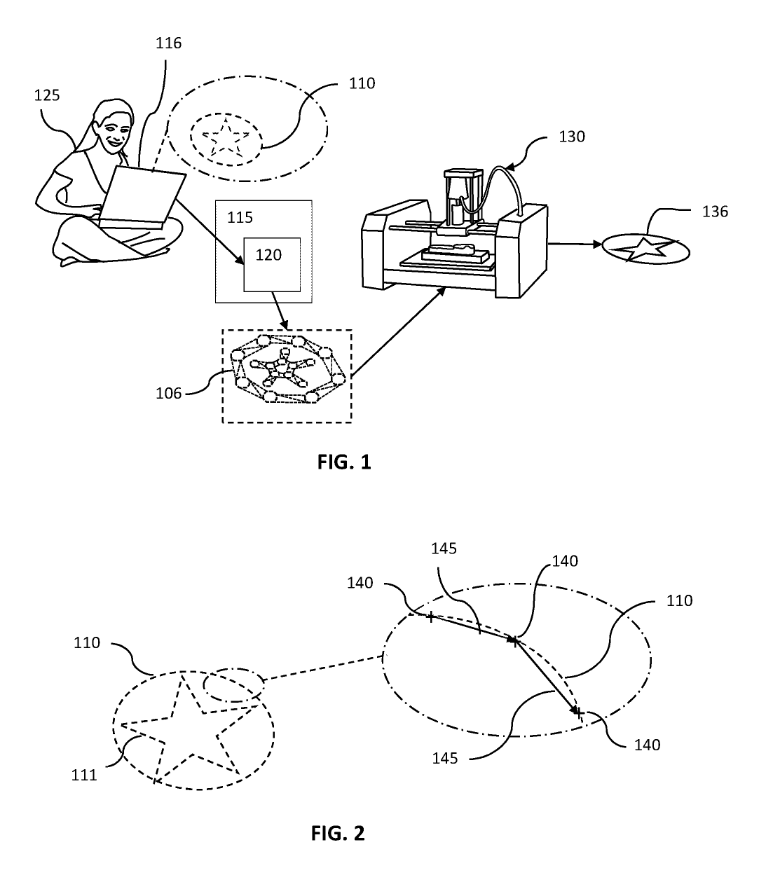

FIG. 1 shows schematic representation of a system of the present invention interactively producing a 3D representation of a vector graphic.

In a preferred embodiment, a user 125 may supply, or select, a vector graphic 110 that may be representative of one or more 2D objects such as, but not limited to, line drawings. The vector graphic 110 may, for instance, be supplied by the user 125 operating a drawing device 116. The vector graphic 110 may, for instance, be supplied via a personal or mobile computing device to a digital computing device 115. The vector graphic may initially be a vector graphic primitive 111 may, for instance, be a shape drawn by the user, or it may be generated by a computer algorithm based on the user's input, such as, but not limited to, a user supplied start point 121, an end point 122 and a name, or a primitive type.

The vector graphic primitive 111 may then be altered, either automatically or with user inputs or with or a combination thereof. Such alteration may be performed, all or in part, using predefined algorithms or scripts, that result in the vector graphic being altered by actions such as, but not limited to, being complemented, being supplemented, being distorted by stretching or compression in one or more dimensions, or some combination thereof. The user may initiate or invoke the algorithms or scripts by means of and input that may be conveyed by an action such as, but not limited to, touch, gesture, voice, light, pressure, bio-sensing inputs such as, but not limited to, heart rate, blood pressure, skin conductivity or some combination thereof, and or by various physically collected inputs such as temperature, or vibration, or some combination thereof.

The digital computing device 115 may be running a software module 120 that may automatically transform the vector graphic 110 into a 3D printable mesh, that may, for instance, be a triangular mesh. This 3D printable mesh 106 may then be translated into a format readable by a 3D printer 130. The 3D printer 130 may then produce a 3D printed object 136, representing the vector graphic, in one of the materials the 3D printer 130 may be capable of printing. The 3D printed object 136 may conform in shape and size to the 3D printable mesh 106.

The format readable by a 3D printer 130 may, for instance, be a language such as STereoLithography file format (STL), Drawing Exchange Format (DXF) or Additive Manufacturing File Format (AMF). These are well-known standards in the industry. STL, for instance, is a language developed specifically for stereo-lithography, an early form of 3D printing, that has become a defacto standard for the industry. STL represents surfaces as consisting of multiple joined triangles specified by the vertices of the triangle in 3D Cartesian coordinates, and the normal to the surface of the triangle, as three orthogonal vectors. AMF is an open standard defined in ISO/ASTM 52915:2013. It is an XML-based format designed to allow any computer-aided design software to describe the shape and composition of any 3D object to be fabricated on any 3D printer. AMF, which is intended to supersede STL, has native support for color, materials, lattices, and constellations.

The 3D printer may operate using any of the well-known 3D printing technologies such as, but not limited to, selective laser sintering (SLS), fused deposition modeling (FDM), direct metal laser sintering (DMLS), selective laser melting (SLM), or stereo-lithography (SLA), or non-additive processes, or some combination thereof. The materials used to create the 3D print may be any of the well-known materials used in 3D printing such as, but not limited to, thermoplastics, thermoplastic powder, photopolymers, resins, Titanium alloys, stainless steel, aluminum, or ceramics, or some combination thereof.

FIG. 2 shows a schematic representation of a vector graphic 110 that may include a vector graphic primitive 111. A portion of a curve of the outer circle is shown magnified. In the magnified portion of the curve, FIG. 2 shows how the curve may be represented, or approximated, by a series of endpoints 140 with vector segments 145 joining the endpoints 140. The representation may have no width. The curve it approximates may be an open ended curve, i.e. a curve in which the starting point and the ending point are not the same point. One of ordinary skill in the art will appreciate that open ended curves may be joined together to form larger open ended curves, or broken apart to form a number of shorter open ended curves. The curve may also, or instead, be joined to form a closed curve.

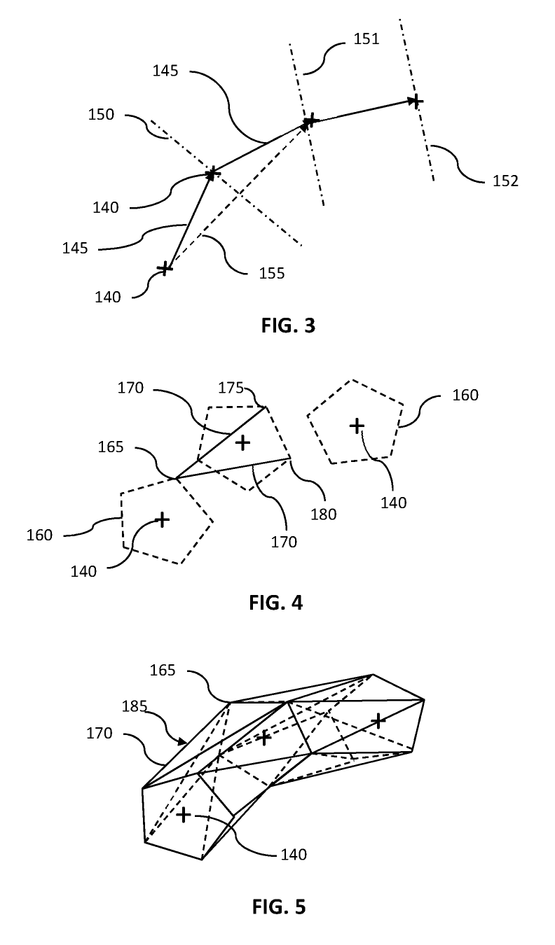

FIG. 3 shows a schematic representation of a step in converting a vector graphic into a 3D machine readable object. In order to draw a polygon associated with an endpoint 140, a suitable orientation for the polygon may need to be determined. This orientation may, for instance, be defined as the plane that includes all the vertices of the polygon.

As shown in FIG. 3, a suitable orientation may be selected as a plane that is oriented substantially orthogonal 150 to the resultant vector 155 formed by adding the two vector segments 145 that join at the endpoint 140. The selected plane preferably also has the property of passing through the endpoint that it may be associated with.

In a preferred embodiment, a computationally simpler method may provide a satisfactory orientation plane. The orientation plane 151 may, for instance, be a plan that may be orthogonal to the vector 145 adjacent the current endpoint but following it. The orientation plane 152 may, for instance, be a plan that may be orthogonal to the vector 145 adjacent the current endpoint but preceding it.

FIG. 4 shows a schematic representation of a further step in converting a vector graphic into a 3D machine readable object. Having selected a plane in which to orient the polygon, a mathematical representation of an n-sided polygon may be automatically generated. FIG. 4 shows a regular pentagon being generated at each end point. The polygons may, however, have any number of sides, and may be irregular polygons.

In a preferred embodiment, the polygons are preferably congruent, regular polygons, i.e., they all have the same number of sides and all the sides of all the polygons are the same size.

In a further preferred embodiment n, the number of sides of the polygon may be six or more, and more preferably eight or greater.

One of ordinary skill in the art will, however, appreciate that there may be implementations in which the size of the polygons may vary with position so the line thickness, i.e., the local cross-sectional area, of the 3D printed object, may be different at different locations within the 3D printed object. There may be applications in which other cross-sections such as, but not limited to, a rectangular cross-section, or a semi-circular cross-section may be desirable. Applications in which the final printed object is to be attached to a flat surface may, for instance, benefit from having a flat base though the cross-section may still be a non-rectangular cross-section such as, but not limited to, a hemispherical cross-section, a triangular cross section or any other polygon not having four sides.

In a preferred embodiment, the polygons may be formed by first generating a circle and then dividing the circle into equal arc segments to obtain the endpoints. In a preferred embodiment, the number of arc segments is preferably 6 or more, and more preferable, at least 8.

FIG. 4 also show how the vertices of the polygons may be joined to form a volume encompassing mesh that may, for instance, be a triangulated mesh, though volume encompassing meshes using other polygons, or combinations of other polygons may also be used. At a given polygon vertex 165 on an-sided polygon 160, a vertex connecting line 170 may be calculated to join that vertex to a corresponding vertex 175 on a next, adjacent polygon. A second vertex connecting lines 170 may also be calculated that joins the polygon vertex 165 to an adjacent vertex 180 on the next polygon, thereby forming a triangle. Repeating this process for each vertex on each polygon may lead to a surface enclosing the vector graphic, with the surface represented as a triangulated mesh.

In FIG. 4, the n-sided polygon 160 is shown centered on the endpoints 140. One of ordinary skill in the art will, however, appreciate that the polygon may have other ways of being associated with the endpoints 140 such as, but not limited to, having one of the vertices located at the endpoints 140, or a midpoint of a side of a polygon located at an endpoint or some combination thereof.

FIG. 5 shows a schematic representation of a vector graphic converted into a triangular mesh 185. The triangulated structure may have a number of vertex connecting lines 170 connecting the polygon vertices 165 in the manner described above. The endpoints 140 may now be fully enclosed by the triangulated surface. One of ordinary skill in the art will, however, appreciate that such a volume enclosing mesh may instead have been constructed using other combinations of regular or irregular polygons such as, but not limited to, squares, regular or irregular quadrilaterals, or some combination thereof. A non-triangular mesh may, for instance, be preferred in some circumstances to reduce the amount of computation needed in creating the mesh, or the amount of space needed to store a digital copy of the mesh.

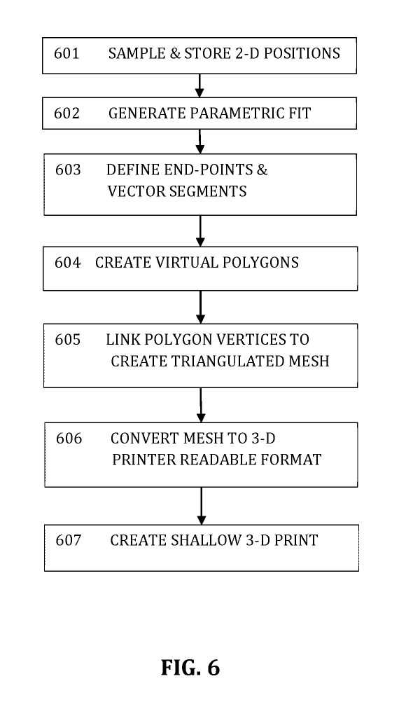

FIG. 6 shows a schematic flow chart of steps in a method for producing a 3D representation of a vector graphic.

Step 601: Sample & Store 2D positions. This step may be a part of providing a 2D vector graphic.

A user may, for instance, use a location detecting device to trace or otherwise draw or define a 2D or 3D pattern or object. The location detecting device may be a device such as, but not limited to, a computer mouse, a stylus, a track ball, a touch screen, a GPS receiver, a motion sensing device, a 3D sensing device, one or more accelerometers or gyroscopes or any other device capable of generating or registering 2D or 3D positional information, with or without user interaction. The device is preferably capable of supplying repeated 2D or 3D positional information as a function of over time, and more preferably at predetermined, constant time intervals. A computer mouse or stylus may, for instance, operate using optical components, pressure sensitive components or motion sensitive components, or a combination thereof.

Having obtained and stored a number of x, y and possibly z coordinate pairs, these may themselves be used as end points, and the straight lines joining them may be used as vector segments that together may constitute the vector graphic.

In a preferred embodiment, a software module may first go to Step 602 and automatically generate a parametric curve, or sequence of parametric curves, that connect the obtained and stored x,y, and possibly z, coordinates. The automatically generated parametric curves may, for instance, be curves such as, but not limited to, B-spline curves, Bézier curves, a non-uniform rational basis spline (NURBS) or some combination thereof.

The software module may then resample the parametric curve in order to obtain a set of intermediate endpoints and use them to generate vector segments as straight lines joining the endpoints in Step 603.

The software module may further allow a user to interact with the parameterized, fitted curve. The software may for instance display the curve on a video screen and allow a user to adjust the shape of the curve using, for instance, the control points on the Bezier curve or the amalgamation of Bezier curves. The module may also enable the user to perform pre-defined transforms, either on the original x, y, and possibly z, sample points or the parameterized representation of the sample points, or the user adjusted curve derived from the sample points.

The software module may further automatically generate line drawings and/or full 3D shapes that may be supplementary or complementary to and therefore combined with user defined drawings or used on their own. These computer/digitally generated lines and/or shapes may be obtained via pre-programmed algorithms and scripts, and may alter or grow to realize a specific end-shape or a particular end goal including but not limited to, arrive at a given object, based on a story or other contextual information. This may be accomplish by methods such as, but not limited to, using pre-programmed, deterministic instructions, using randomized values of generative parameters to augment pre-programed instructions, or in a manner dependent upon one or more values supplied via user interaction at a given point in time during the operation of the program, or some combination thereof. The user interaction may be via means such as, but not limited to, gesture, touch, voice, biofeedback or bio-sensing methods that may involve measuring user controllable functions such as, but not limited to, heart rate, blood pressure, brainwaves, muscle tone, skin conductance, heart rate and pain perception, or some combination thereof. For instance, growth of complementary line drawing may not be generated until a user's heart rate drops below a certain value, or different supplementary line drawings may be generated dependent on the value of the measured heart rate.

The automatically generated additional line drawings may, for instance, be added using augmentation module that may be operable on the digital device. This augmentation module may, for instance, augment the original vector graphic, that may be a user created line drawing, with an automatically generated additional vector graphic. The augmentation module may be configured such that the additional vector graphic varies dependent on further user input. That further user input may, for instance, be information such as, but not limited to, gesture, voice or bio-feedback or bio-sensing information.

Once the user is satisfied with the shape of the curve, the software module may then proceed to Step 603: Define End-points and Vector Segments. In this step the curve, as adjusted by the user, may be resampled, and the resampled x, y, and possibly z, coordinates used as end-points. Those end-points may then be used to define vector segments along straight lines joining them, thereby defining a 2D vector graphic.

Step 604: Create virtual polygons. As detailed above, in a preferred embodiment of the present invention, this may be accomplished by first generating virtual circles, one centered on each of endpoints, and located in a plane that is perpendicular to the result vector of the two vector segments linked directly to that endpoint. The radius of the circle may depend on a number of factors such as, but not limited to, the print material being used, a print method being used and a scaling factor, or some combination thereof. The scaling factor may, for instance, be required to convert a curve such as, but not limited to, a sequence of dance moves captured by a GPS or other location detector, then scaled to form a 2D or 3D vector graphic representative of the dance routine but of a size that may be printed by an available 3D printer. The height of a dancer's center of gravity may, for instance, also be captured and represented by a color of material printed at that point, or by a thickness of a line, i.e., a cross sectional area of the printed object being printed at that point.

The circles may then be converted into a series of congruent, regular polygons by dividing the circumference of the circle into equal parts. In a preferred embodiment, there may be at least 6 equal parts, and in a more preferred embodiment, at least 8 equal parts, or sides of a polygon, though various embodiments may have as many as 24 or even more sides.

In a further preferred embodiment of the invention, the radius of the circle may be adjusted to reflect a further parameter of the data captured by the motion detecting and sampling device described above. The further parameter may, for instance, be a property such as, but not limited to, a pressure being applied to the device at the point captured, a velocity of the device at the point captured, a further action of the user such as, but not limited to, a mouse button being depressed, interaction with a user interface (UI) software widget or app, interaction with a UI device, a gesture being performed, a voice input or a keyboard key being held down or otherwise activated, or some combination thereof.

The number of parts the circumference is divided into may, however, be consistent so that all the polygons are similar. The polygons may be regular, i.e., have all their sides equal, or they may differ in order, for instance, to approximate a semi-circular cross section or a rectangular cross section, both of which may have benefits if the final 3D representation of a vector graphic is to be attached to, or displayed on, a flat surface.

Step 605: Link Polygon vertices to create triangulated mesh. As described above, the vertices may be joined to form a triangulated mesh by joining each vertex first to a corresponding vertex on the next adjacent polygon, and then with another line to a vertex on the next adjacent polygon that is adjacent to the corresponding vertex. Such a mesh may form a surface, but that surface may not be optimal. An optimal surface may, for instance, be one in which all the triangles of the mesh have the maximum minimum-internal-angle between joined sides. Such triangles are called Delaunay triangles and may be characterized by the circumcircle of any triangle of a mesh enclosing no more than three end-points. There are well-known algorithms for computationally efficient ways of converting any triangulated mesh into a triangulated mesh in which all triangles are Delaunay triangles. Such algorithms include, but are not limited to, divide and conquer algorithm for triangulations in two dimensions due to Lee and Schachter and improved first by Guibas and Stolfi and later by Dwyer, sweep-line algorithms by Fortune, and sweep-hull algorithms.

Other issues or aberrations associated with automatic creation of triangulated meshes include problems such as, but not limited to, self-intersecting portions of the mesh, the resultant holes in the mesh or unnecessary lines, or some combination thereof. These are typically ill-defined problems, i.e., they are problems that may have more than one legitimate solution. Never the less, there are a number of software modules designed to attempt to address such problems, with varying assumptions as to what an ideal or legitimate result would be. These programs include, but are not limited to, MeshFix™, PolyMender™, ReMesh™ and TrIMM™. One of these programs may be run to repair a mesh, or the algorithms employed by such software may be incorporated within the software module of the present invention.

Once a satisfactory mesh has been created, Step 606 of Convert Mesh to 3D Printer Readable format may be implemented. 3D Printer's typically read and print files have the structure defined in STL format. It may be possible to convert xyz files into STL format using in-house created software modules or using open source software modules and libraries or commercially available software such as but not limited to, MeshLab™, Embossify™ and AnyCAD Exchange3D™.

Having produced a file that may be read by a 3D printer, the file may then be sent to a 3D printer for printing as a 3D representation of the vector graphic. The 3D printer may be local, and may be connected to the device generating the readable files, or the 3D printer may remote and accessed via a communications network such as, but not limited to, the internet. The 3D printing may, for instance, be offered as part of a printing service.

In a further preferred embodiment of the invention, the software module may incorporate an image such as, but not limited to, a jpeg or tiff image, as a basis for tracing. The module may also be able to automatically perform image or pattern recognition functions such as, but not limited to, edge detection or boundary thresh-holding, using computer vision methods including but not limited to the Sobel operator, Canny edge detection, and/or segmentation methods resulting in the definition of a curve, to automatically extract a contour and provide some or all of a vector graphic, or some or all of a seed for a vector graphic.

A module may load a guide such as, but not limited to, an image, a regular grid, a parallel line or some combination thereof that can be used as a visual help or as a drawing guide for a user. The user drawing may, for instance, be displayed as an overlay on top of the guide.

If the guide is an image, the module may incorporate a computer vision method for automatically or semi-automatically detecting contours from the image. The computer vision methods may also or instead be used for sensing user inputs and interactions, using algorithms such as, but not limited to, optical flow-based motion sensing to detect user gesture).

The module may also incorporate a post-processing step to generate more complex shapes via interaction with the user and/or automated transformations.

In a further preferred embodiment of the invention, the device used to input the vector graphic, or the sample points used to obtain the end-points of the vector graphic, may be responsive to pressure applied to the device. The pressure sensed as the vector graphic, or the proto-vector graphic, or a portion thereof, is being generated may be reflected in the final flat 3D print as a change in some characteristic such as, but not limited to, the thickness, the cross-section, the color or the material printed or some combination thereof.

In a further preferred embodiment of the invention, the 3D printed object may be attached to another object such as, but not limited to, a photograph, a painting, a printed page, a wall, an item of clothing, a piece of jewelry, a craft or hardware item, or some combination thereof. The attachment may be by a means such as, but not limited to, an adhesive, stitching, riveting, melting or some combination thereof.

In a still further preferred embodiment, the invention may include data capture by a fully 3D pen. Such a pen may, for instance, capture 3D motion by means of one or more accelerometers as a tip of the pen is moved by a user in 3D space. The captured motion may, for instance, be displayed on a computer screen using software such as, but not limited to, 3D modeling software. The pen may also include function buttons, or pressure sensors that enable a used to specify color, object width, material to be printed or some combination thereof. Such a 3D pen may, for instance, be implemented as an app on a smartphone or as a custom item of hardware.

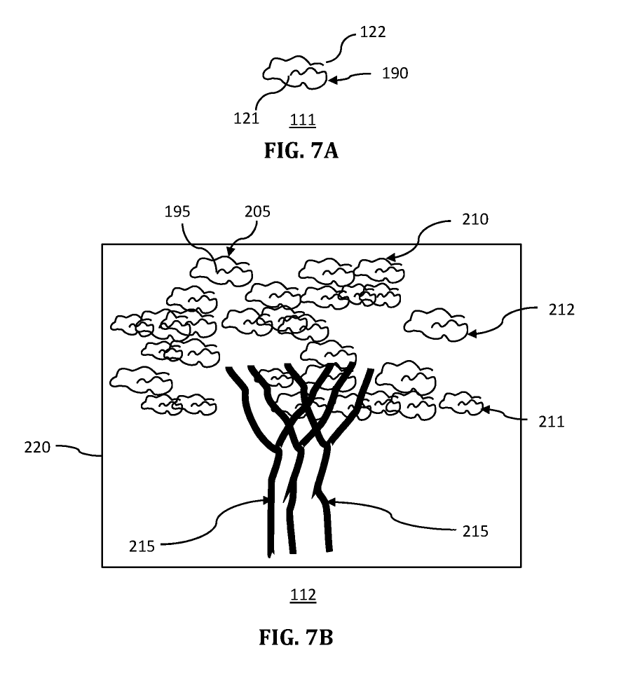

FIG. 7A shows a schematic rendering of a vector graphic primitive of one embodiment of the present invention.

The vector graphic primitive 111 may have a user-input sketch 190 that may have a start point 121 and an end point 122.

FIG. 7B shows a schematic rendering of a composite vector graphic 112 of one embodiment of the present invention.

The composite vector graphic 112 may be located on, or drawn on, a current input plane 220. The composite vector graphic 112 may include one or more instantiations 205 of a vector graphic primitive such as, but not limited to, a user-input sketch 190, each having a start point located at an object start-location 195. The object start-locations 195 may be selected by a user, or may be generated automatically by, for instance, a user selected, predetermined growth algorithm, as discussed in more detail below.

The instantiations of the vector graphic primitive may also be selected to be a random-sized instantiation 210. These may be selected to be, for instance, randomly within 90% to 110% of the original size, or within 50% to 150% of the original size. The randomized instantiations may, for instance, be used to provide a more natural, or artisanal look, to the completed composite vector graphic 112. As shown in FIG. 7B, these instantiations of random-sized instantiations 210 may include undersized-sized instantiation 211 and/or oversized-sized instantiations 212.

The instantiations of the vector graphic primitive may also be selected to be randomly-structured instantiations 215 of the vector graphic primitive. The randomly-structured instantiations 215 may, for instance, vary the length of, or joining angles between, one or more of the line elements that make up the vector graphic primitive. The number, range of length deviations and range of angle deviations may all be preset, or user selected.

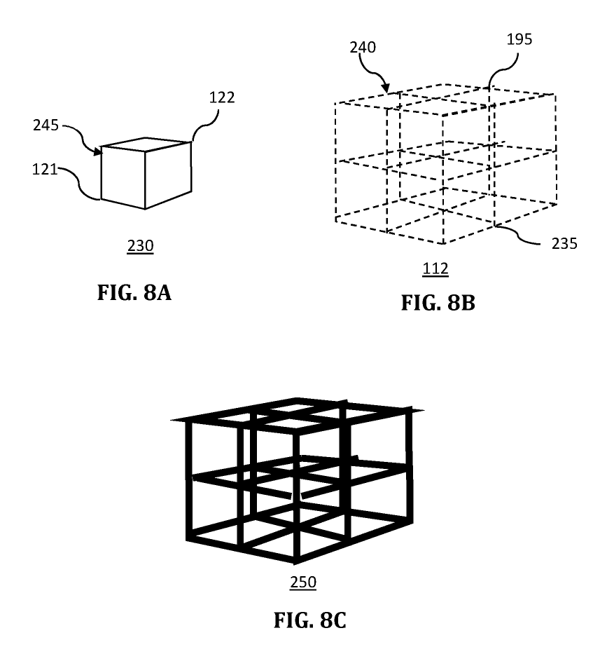

FIG. 8A shows a schematic rendering of a user-selected unit-cell of one embodiment of the present invention.

The user-selectable unit-cell 230 may be a vector graphic primitive having a cube-shaped wire frame 245 that includes a start point 121 and an end point 122.

FIG. 8B shows a schematic rendering of a predetermined growth algorithm of one embodiment of the present invention.

Having selected a vector graphic primitive that may be a unit-cell 230, the user may then select a predetermined growth algorithm that may, for instance, be the vertices 235 of a 3D lattice structure. Such a 3D lattice structure 235 may have user selectable features such as, but not limited to, a number of repeats in each of an x, y and z axis, and a spacing of the repeats in each of the x, y and z axis.

The system may then generate a wire-frame model of a 3D lattice 240 by providing instantiations of the user-selected unit-cell at each of the object start-locations 195, i.e., at each of the vertices 235 of the 3D lattice structure. The resultant wire-frame model of a 3D lattice 240 may then be treated as a composite vector graphic 112 and converted into a 3D printable mesh using the methods described above.

FIG. 8C shows a schematic rendering of a 3D printed lattice of one embodiment of the present invention.

The composite vector graphic 112 shown in FIG. 8C, having been converted into a 3D printable mesh, may then be printed using a 3D printer to produce the 3D printed lattice 250.

One of ordinary skill in the art will appreciate that such lattices may be of benefit providing beneficial mechanical characteristics to the material it is printed from. For instance, the lattice may also reduce the amount of material required to produce a desired mechanical characteristic.

One of ordinary skill in the art will further appreciate that although the concept of lattice construction has been described using a cube-shaped wire frame as the unit-cell, and the vertices 235 of a 3D lattice structure as the predetermined growth algorithm, other unit cells and other lattice structures may be used effectively to produce desired lattices.

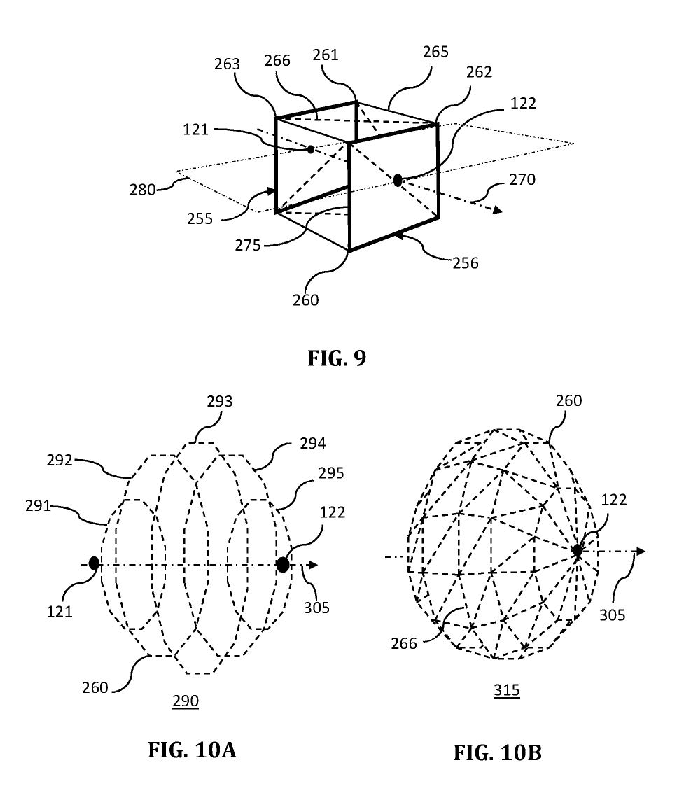

FIG. 9 shows a schematic rendering of a 3D printed cube of one embodiment of the present invention.

A user may, for instance, be select the graphic primitive to be a cube and may then select a start point and end point separated by a distance D. The system may then automatically generate a vector graphic that is a wire frame, mathematical representation of the cube. This may, for instance, be done by generating two squares a first square 255 and a second square 256. These square may each have sides of length D that may be the distance between the user selected start point 121 and end point 122. The squares may each be defined by a set of four vertices 260. The system may then automatically generate a set of vectors 265 connecting all of the vertices, thereby defining the cube as a 3D printable mesh, which may, for instance, be a square mesh or a triangular mesh, or a combination thereof.

In a preferred embodiment, the plane containing each of the squares is preferably orthogonal to a base vector 270 that joins the user selected start point to the user selected end point. Moreover, the first square is preferably centered on the start point, and the second square on the end point. In a further preferred embodiment of the invention, both squares are oriented that each has two sides 275 that are perpendicular to an input plane 280 in which the cube was selected. The input plane 280 may, for instance, be the currently displayed plane of a drawing device being used to make the selection of a cube as a vector graphic primitive.

Other vector graphic primitives that may be constructed using similar methods include, but are not limited to, convex polyhedrons, parallelepipeds, spheres, diamonds, pyramids, and ellipsoids.

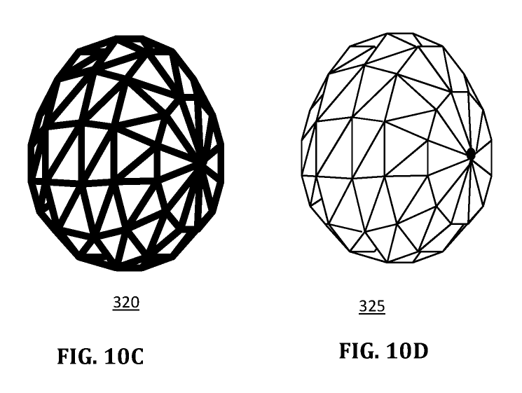

FIG. 10A shows a schematic rendering of a polygons approximating a sphere of one embodiment of the present invention.

A user may, for instance, select the vector graphic primitive to be of a type “sphere”, and then characterize that sphere by selecting a start point 121 and end point 122 that may be separated by a distance 2R, that may represent the diameter of the sphere. The system may then begin constructing an approximation to the sphere by first constructing a joining vector 305, that may be of length 2R and may join start point 121 to end point 122. This joining vector 305 may then be automatically divided into parts, which may be N equal lengths of size x=2R/N. At each of the nodes created by this division, the system may construct a polygon. These polygons 290 may be drawn in planes that are orthogonal to the joining vector 305. The polygons 290 may also be drawn on circles centered on the nodes into which the joining vector has been divide, and those circles may have a radius equal to SQRT (2R·nx−nx·nx), where n represents which number node the polygon is being drawn at. The radius of the circle on which the polygons 290 approximating a sphere is drawn may, therefore, be equal to the square root of the difference between the diameter times the distance of the node from the start point and the square of the distance of the node from the start point. The polygon may be either regular or irregular, and may have a pre-defined, or user selected, number of sides that may depend on how accurate a representation of a sphere is required, or on a concern for limiting the total number of vertices either because of constraints on computational capacity or data storage capacity.

FIG. 10A shows the polygons 290 approximating a sphere as the set of polygons having a first polygon 291, a second polygon 292, a third polygon 293, a fourth polygon 294 and a fifth polygon 295. One of ordinary skill in the art will, however, appreciate that the number of polygons, and the number of vertices 260 of each polygon may be selected according to how accurately a representation of a sphere the final wire frame needs to be, with due respect for the availability of computational power and data storage. These may be predefined, may automatically depend on the sphere's diameter or may be user selected.

FIG. 10B shows a schematic rendering of a sphere approximated by tessellated polygons of one embodiment of the present invention.

The sphere 315 approximated by tessellated polygons may be a result of joining the vertices 260 of the polygons approximating the sphere by triangulating vectors 266. The result may be a vector graphic primitive that may be an approximately spherical 3D printable mesh.

FIG. 10C shows a schematic rendering of a 3D printed spherical mesh of one embodiment of the present invention. The 3D printed spherical mesh 320 of FIG. 10C may be accomplished by adding volume to the spherical 3D printable mesh of FIG. 10B using the methods described above, as articulated in, for instance, the description of FIGS. 4 and 5.

FIG. 10D shows a schematic rendering of a 3D printed sphere of one embodiment of the present invention.

In FIG. 10D, the sphere 315 approximated by tessellated polygons may be realized as a solid object, rather than as the mesh of FIG. 10C.

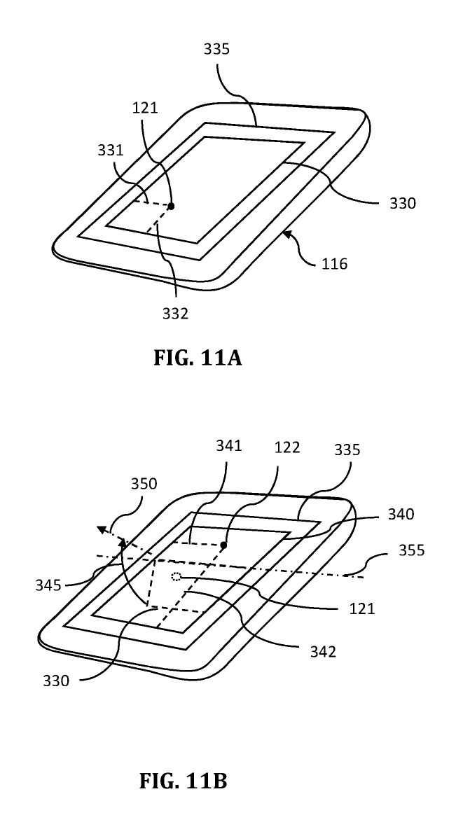

FIG. 11A shows a schematic rendering of a drawing device of one embodiment of the present invention.

A drawing device 116 may have a device display screen 335 on which a first 2D input plane 330 may be displayed. A user may then enter data, such as, but not limited to, a start point 121, by indicating a first plane x coordinate 331 and a first plane y coordinate 332. The device display screen 335 may, for instance, be a touch screen and the data may be entered a user pressing on the screen at the appropriate location. The data may also, or instead, be entered by one of a number of well-known data entry mechanisms such as, but not limited to, a numeric keypad, and alphanumeric keypad, a virtual keypad or voice recognition data entry, or some combination thereof.

FIG. 11B shows a schematic rendering of a drawing device of a further embodiment of the present invention.

In defining a vector graphic primitive, the user, having entered a data point, such as a start point as an x and a y coordinate, both referenced with respect to a first 2D input plane, may then select a second 2D input plane 340. This second 2D input plane 340 may, for instance, have a first angle of rotation 345, and optionally a translation, with respect to said first 2D input plane. The user may then enter another vertex of the vector graphic primitive as a point, such as an end point 122, having a second plane x coordinate 341 and a second plane y coordinate 342, both referenced with respect to the second 2D input plane. The system may then convert the x, y coordinates of the points entered in the two different frames of reference into x, y, and z coordinates of points in a single, common 3D frame of reference. This conversion may be done automatically using well-known geometric transformation formulas.

One of ordinary skill in the art will appreciate that although the description above is given using Cartesian coordinates, the method may be applied using any suitable coordinate system such as, but not limited to, polar coordinates.

One of ordinary skill in the art will further appreciate that although the axis 355 about which the first 2D input plane is rotated to arrive at the second 2D input plane is shown in FIG. 11B as being essentially parallel to the base of the drawing device, the axis may be oriented at any user selected angle, and may extend out from the plane of the first input plane in a z direction, i.e., it may have a component that may be orthogonal to the first 2D input plane.

In a further embodiment of the invention, the drawing device may be presented using virtual reality, or augmented reality technology. In such an embodiment, the 2D input plane may be a virtual 2D input plane.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1: A method for producing a 3D printed object, comprising:
providing a 3D printer;
providing a digital computing device;
providing a drawing device;
using said drawing device to define a vector graphic primitive comprising a primitive type, a start point and an end point;
automatically generating a 3D printable mesh from said vector graphic primitive;
converting said 3D printable mesh into instructions readable by said 3D printer; and
printing said converted 3D printable mesh using said 3D printer, thereby creating said 3D printed object corresponding in shape to said vector graphic primitive.

2: The method of claim 1, wherein, said primitive type is a user-input sketch, and further comprising said user selecting one or more object start locations in a current input plane; and, automatically generating an instantiation of said vector graphic primitive at each selected object start location.

3: The method of claim 2, further comprising, said user selecting one of size randomization and a structural randomization, or a combination thereof; and wherein if size randomization is selected each instantiation of said vector graphic primitive generates a random-sized instantiation of said user-input sketch; and if structural randomization is selected, each instantiation of said vector graphic primitive generates a randomly-structured instantiation of said user-input sketch.

4: The method of claim 2, further comprising a predetermined growth algorithm, and wherein said object start locations are selected according to said predetermined growth algorithm.

5: The method of claim 1, wherein, said primitive type is a user-selected unit-cell, and further comprising:
said user selecting a predetermined growth algorithm;
automatically generating, using said predetermined growth algorithm, one or more object start-locations; and
automatically generating an instantiation of said vector graphic primitive at each selected object start-location, thereby creating a composite vector graphic.

6: The method of claim 5, wherein, said user-selected unit-cell is a cube-shaped wire frame, said predetermined growth algorithm generates two or more vertices of a 3D lattice structure, said composite vector graphic is a wire-frame model of a 3D lattice, and said 3D printed object is a 3D printed lattice.

7: The method of claim 1, wherein said graphic primitive is one of a convex polyhedron, a cube, a parallelepiped, a sphere, a diamond, a pyramid, and an ellipsoid; and wherein said 3D printable mesh is a polygonal mesh.

8: The method of claim 7, wherein, said graphic primitive is selected to be a cube; said start point and end point are separated by a distance D; and further comprising automatically generating a first square and a second square, each having sides of length D defined by a set of four vertices; and automatically generating a set of vectors connecting all of said vertices, thereby defining said cube as said 3D printable mesh.

9: The method of claim 8, wherein, a plane of each of said squares is orthogonal to a base vector joining said start point and said end point, the first square is centered on said start point, and said second square is centered on said end point, and each square has two sides that are perpendicular to an input plane in which said cube was selected.

10: The method of claim 7, wherein, said graphic primitive is selected to be a sphere, said start point and end point are separated by a distance 2R and wherein said sphere is approximated by automatically dividing said distance 2R into N equal lengths, of size x=2R/N, and constructing polygons at each of the nodes created by said division, said polygons being in an orthogonal plane to a joining vector joining said start and end points, and being drawn on circles centered on said joining vector and having a radius equal to SQRT(2R·nx−nx·nx), where n represents which number node the polygon is being drawn at.

11: The method of claim 1, wherein defining said vector graphic primitive, further comprises:
selecting a first 2D input plane using said drawing device;
defining said start point by an x and a y coordinate referenced with respect to said first 2D input plane;
selecting a second 2D input plane having a first angle of rotation with respect to said first 2D input plane;
defining said end point having an x and a y coordinate referenced with respect to said second 2D input plane;
converting said start and end points to a single 3D frame of reference having an x, a y and a z coordinate;
and defining a graphic primitive type, incorporating said converted start and end points.

12: The method of claim 11, wherein said graphic primitive type is a user-input sketch and where said user-input sketch comprises one or more first plane points having x and y coordinates selected in said 1st 2D input plane, and one or more second plane points having x and y coordinates selected in said 2nd 2D input plane

13: The method of claim 12, wherein, said drawing device comprises a 2D touch screen.

14: The method of claim 13, wherein, said first angle of rotation is about an axis is selected from being parallel to, or having an orthogonal component to, said first 2D input plane.

15: The method of claim 12, wherein, said drawing device comprises a virtual 2D input plane.
